(19) United States
(12) Patent Application Publication
(10) Pub. No.: US 2025/0286130 A1
(43) Pub. Date: Sep. 11, 2025

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: TAE HYON BAE, Yongin-si (KR); Harim LEE, Yongin-si (KR); Sanghyung KIM, Yongin-si (KR); Seunghyeon SON, Yongin-si (KR); Sangheon LEE, Yongin-si (KR); CHEONSOO KIM, Yongin-si (KR)

(21) Appl. No.: 18/806,628

(22) Filed: Aug. 15, 2024

(30) Foreign Application Priority Data
Mar. 11, 2024 (KR) 10-2024-0034010

(51) Int. Cl. H01M 10/0567; H01M 4/02; H01M 4/36; H01M 10/052; H01M 10/0569

(52) U.S. Cl. CPC H01M 10/0567; H01M 4/364; H01M 10/052; H01M 10/0569; H01M 2004/027

(57) ABSTRACT

An electrolyte and rechargeable lithium batteries including the same are provided. The electrolyte includes a non-aqueous organic solvent, a lithium salt, a first additive including a compound represented by Chemical Formula 1, and a second additive.

### CROSS-REFERENCE TO RELATED APPLICATION

This application claims priority to and the benefit of Korean Patent Application No. 10-2024-0034010, filed on Mar. 11, 2024, in the Korean Intellectual Property Office, the entire content of which is incorporated herein by reference.

### BACKGROUND

### 1. Field

According to one or more embodiments, the present disclosure relates to an electrolyte for a rechargeable lithium battery and a rechargeable lithium battery including the same.

### 2. Description of the Related Art

Recently, with the rapid spread of battery-utilizing electronic devices, such as mobile phones, laptop computers, electric vehicles, and/or the like, there is a rapidly increasing desire or demand for rechargeable batteries with relatively high energy density and relatively high capacity. Therefore, intensive research has been conducted to improve performance of rechargeable lithium batteries.

A rechargeable lithium battery includes a positive electrode, a negative electrode, and an electrolyte. The positive and negative electrodes each include an active material in which intercalation and deintercalation (e.g. of lithium ions) are possible. For example, the rechargeable lithium battery generates electrical energy caused by oxidation and reduction reactions if (e.g., when) lithium ions are intercalated and deintercalated.

A lithium salt dissolved in a non-aqueous organic solvent is utilized as the electrolyte of the rechargeable lithium battery. Performance characteristics of the rechargeable lithium battery are exhibited by complex reactions between the positive electrode and the electrolyte and/or between the negative electrode and the electrolyte. Accordingly, the selection of an appropriate or suitable electrolyte is an important variable for improvement of the performance characteristics of the rechargeable lithium battery.

### SUMMARY

One or more aspects are directed toward an electrolyte for a rechargeable lithium battery, which electrolyte has improved impregnability (e.g., into an electrode (e.g., a negative electrode)).

One or more aspects are directed toward a rechargeable lithium battery including the electrolyte.

Additional aspects will be set forth in part in the description which follows and, in part, will be apparent from the description, or may be learned by practice of the presented embodiments of the disclosure.

According to one or more embodiments of the present disclosure, an electrolyte for a rechargeable lithium battery includes: a non-aqueous organic solvent; a lithium salt; and a first additive including a compound represented (e.g., expressed) by Chemical Formula 1.

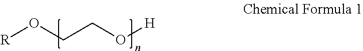

In Chemical Formula 1, R may be a substituted or unsubstituted branched C3 to C15 alkyl group, and n may be an integer of 5 to 10.

According to one or more embodiments of the present disclosure, a rechargeable lithium battery includes: a positive electrode that includes a positive electrode active material; a negative electrode that includes a negative electrode active material; and the electrolyte as described herein.

### BRIEF DESCRIPTION OF DRAWINGS

FIG. 1 illustrates a simplified conceptual diagram showing a rechargeable lithium battery according to one or more embodiments of the present disclosure.

FIGS. 2-5 illustrate simplified cross-sectional views each showing a rechargeable lithium battery according to one or more embodiments of the present disclosure.

FIG. 6 illustrates images showing impregnability test results of electrolytes according to Comparative Examples 1 to 3 and Example Embodiments 1 to 4.

FIG. 7 illustrates a graph showing results of thicknesses of rechargeable lithium batteries according to Comparative Examples 1 to 3 and Example Embodiments 1 to 4.

### DETAILED DESCRIPTION

In order to sufficiently understand the configuration and effect of the present disclosure, some embodiments of the present disclosure will be described with reference to the accompanying drawings. It should be noted, however, that the present disclosure is not limited to exemplary embodiments, and is implemented in one or more suitable forms. Rather, the exemplary embodiments are provided only to disclose the present disclosure and let those skilled in the art fully know the scope of the present disclosure. One or more example embodiments of present disclosure are illustrated in the accompanying drawings, wherein like reference numerals refer to like elements throughout, and duplicative descriptions thereof may not be provided. In the drawings, the thickness of layers, films, panels, regions, and/or the like, are exaggerated for clarity.

In this description, it will be understood that, if (e.g., when) an element is referred to as being on another element, the element may be directly on the other element or intervening elements may be present between therebetween. In the drawings, thicknesses of some components are exaggerated for effectively explaining the technical contents. Like reference numerals refer to like elements throughout the specification.

Unless otherwise specially noted in this description, the expression of singular form may include the expression of plural form. In some embodiments, unless otherwise specially noted, the phrase “A or B” may indicate “A but not B”, “B but not A”, and “A and B”. The terms “comprises/includes” and/or “comprising/including” used in this description do not exclude the presence or addition of one or more other components. For example, terms such as “comprises,” “comprise,” “comprising,” “includes,” “including,” “include,” “having,” “has,” and/or “have” are intended to designate the presence of an embodied aspect, number, step (e.g., act or task), element, and/or a (e.g., any suitable) combination thereof, and do not preclude the possibility of the presence or addition of one or more other features, numbers, steps (e.g., acts or tasks), elements, and/or a (e.g., any suitable) combination thereof.

As used herein, the term “combination thereof” may refer to a mixture, a stack, a composite, a copolymer, an alloy, a blend, or a reaction product.

In one or more embodiments, the term “layer” herein includes not only a shape formed on the whole surface if (e.g., when) viewed from a plan view, but also a shape formed on a partial surface.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the teachings set forth herein.

As utilized herein, the term “and/or” includes any, and all, combinations of one or more of the associated listed items. Expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper” and/or the like, may be utilized herein to easily describe the relationship between one element or feature and another element or feature. It will be understood that the spatially relative terms are intended to encompass different orientations of a device in utilization or operation in addition to the orientation illustrated in the drawings. For example, if (e.g., when) the device in the drawings is turned over, elements described as “below” or “beneath” other elements or features will be oriented “above” the other elements or features. Thus, the example term “below” may encompass both (e.g., simultaneously) the orientations of above and below. The device may be otherwise oriented (rotated 90 degrees or at other orientations), and the spatially relative terms utilized herein may be interpreted accordingly.

The terminology utilized herein is utilized for the purpose of describing particular embodiments only, and is not intended to limit the present disclosure. Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

Example embodiments are described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the present claims.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

In this context, “consisting essentially of” indicates that any additional components will not materially affect the chemical, physical, optical or electrical properties of the semiconductor film.

Further, in this specification, the phrase “on a plane,” or “plan view,” indicates viewing a target portion from the top, and the phrase “on a cross-section” indicates viewing a cross-section formed by vertically cutting a target portion from the side.

As used herein, the terms “use,” “using,” and “used” may be considered synonymous with the terms “utilize,” “utilizing,” and “utilized,” respectively. Descriptions of features or aspects within each embodiment should typically be considered as available for other similar features or aspects in other embodiments.

In this description, unless otherwise separately defined, the term “substituted” may refer to that at least one hydrogen of a substituent or a compound is substituted by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, or a combination thereof.

In detail, the term “substituted” may refer to that at least one hydrogen of a substituent or a compound is substituted by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may refer to that at least one hydrogen of a substituent or a compound is substituted by deuterium, a halogen group, a C1 to C20 alkyl group, a C6 to C30 aryl group, a C1 to C10 fluoroalkyl group, or a cyano group. Alternatively, the term “substituted” may refer to that at least one hydrogen of a substituent or a compound is substituted by deuterium, a halogen group, a C1 to C5 alkyl group, a C6 to C18 aryl group, a C1 to C5 fluoroalkyl group, or a cyano group. For example, the term “substituted” may refer to that at least one hydrogen of a substituent or a compound is substituted by deuterium, a cyano group, a halogen group, a methyl group, an ethyl group, a propyl group, a butyl group, a phenyl group, a biphenyl group, a terphenyl group, a trifluoromethyl group, or a naphthyl group.

In this description, the halogen atom may be, for example, a fluorine atom, a chlorine atom, a bromine atom, or an iodine atom.

Unless otherwise defined in this description, an alkyl group may be a linear alkyl group or a branched alkyl group. The number of carbon atoms in the alkyl group may range from 1 to 30, from 1 to 20, from 1 to 10, or from 1 to 6. The alkyl group may include, for example, one or more of methyl group, ethyl group, n-propyl group, isopropyl group, n-butyl group, s-butyl group, t-butyl group, i-butyl group, 2-ethylbutyl group, 3,3-dimethylbutyl group, n-pentyl group, i-pentyl group, neopentyl group, t-pentyl group, 1-methylpentyl group, 3-methylpentyl group, 2-ethylpentyl group, 4-methyl-2-pentyl group, n-hexyl group, 1-methylhexyl group, 2-ethylhexyl group, 2-butylhexyl group, n-heptyl group, 1-methylheptyl group, 2,2-dimethylheptyl group, 2-ethylheptyl group, 2-butylheptyl group, n-octyl group, t-octyl group, 2-ethyloctyl group, 2-butyloctyl group, 2-hexyloctyl group, 3,7-dimethyloctyl group, n-nonyl group, n-decyl group, adamantyl group, 2-ethyldecyl group, 2-butyldecyl group, 2-hexyldecyl group, 2-octyldecyl group, n-undecyl group, n-dodecyl group, 2-ethyl-dodecyl group, 2-butyl-dodecyl group, 2-hexyl-dodecyl group, 2-octyl-dodecyl group, n-tridecyl group, n-tetradecyl group, n-pentadecyl group, n-hexadecyl group, 2-ethylhexadecyl group, 2-butylhexadecyl group, 2-hexylhexadecyl group, 2-octylhexadecyl group, n-heptadecyl group, n-octadecyl group, n-nonadecyl group, n-eicosyl group, 2-ethyleicosyl group, 2-buty-leicosyl group, 2-hexyleicosyl group, 2-octyleicosyl group, n-heneicosyl group, n-docosyl group, n-tricosyl group, n-tetracosyl group, n-pentacosyl group, n-hexacosyl group, n-heptacosyl group, n-octacosyl group, n-nonacosyl group, and n-triacontyl group, but the present disclosure is not limited thereto.

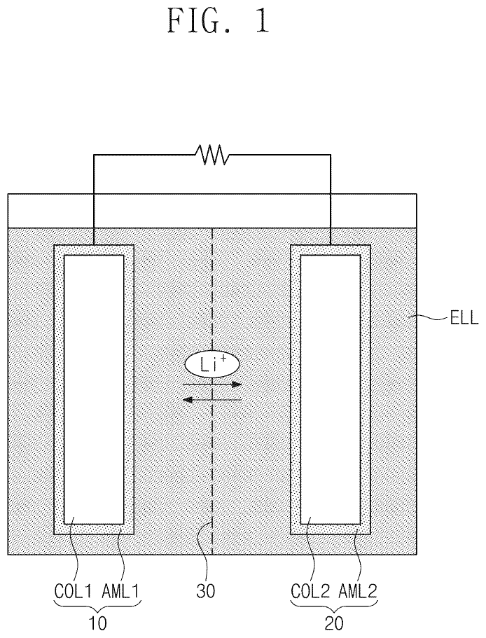

### Description of FIG. 1

FIG. 1 illustrates a simplified conceptual diagram showing a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart from each other across the separator 30. The separator 30 may be arranged between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material and may further include a binder and/or a conductive material.

For example, the positive electrode 10 may further include a component that may serve as a sacrificial positive electrode.

An amount of the positive electrode active material may range from about 90 wt % to about 99.5 wt % relative to 100 wt % of the positive electrode active material layer AML1. Amounts of the binder and the conductive material may each independently be about 0.5 wt % to about 5 wt % relative to 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may be used to provide an electrode with conductivity, and any suitable conductive material that avoids causing chemical change of a battery may be used as the conductive material of (e.g., to constitute) the battery. The conductive material may include, for example, a carbon-based material such as at least one selected from among natural graphite, artificial graphite, carbon black, acetylene black, Ketjenblack, carbon fiber, carbon nano-fiber, and carbon nano-tube; a metal powder or metal fiber containing one or more of (e.g., at least one selected from among) copper, nickel, aluminum, and silver; a conductive polymer such as a polyphenylene derivative; or a mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., lithiated intercalation compound) that reversibly intercalates and deintercalates lithium. For example, the positive electrode active material may include at least one kind of composite oxide including lithium and a metal that is selected from among cobalt, manganese, nickel, and a combination thereof.

The composite oxide may be or include a lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound represented (e.g., expressed) by at least one of chemical (e.g., at least one selected from among) formulae herein. For example, LiₐA_{1-b}X_{b}O_{2-c}D_{c} (0.90≤a≤1.8, 0≤b≤0.5, 0≤c≤0.05), LiₐMn_{2-b}X_{b}O_{4-c}D_{c} (0.90≤a≤1.8, 0≤b≤0.5, 0≤c≤0.05), LiₐNi_{1-b-c}Co_{b}X_{c}O₂₋ₐDₐ (0.90≤a≤1.8, 0≤b≤0.5, 0≤c≤0.5, 0<α<2), LiₐNi_{1-b-c}Mn_{b}X_{c}O₂₋ₐDₐ (0.90≤a≤1.8, 0≤b≤0.5, 0≤c≤0.5, 0<α<2), LiₐNi_{b}Co_{c}L¹_{d}GeO₂ (0.90≤a≤1.8, 0≤b≤0.9, 0≤c≤0.5, 0≤d≤0.5, 0≤e≤0.1), LiₐNiG_{b}O₂ (0.90≤a≤1.8, 0.001≤b≤0.1), LiₐCoG_{b}O₂ (0.90≤a≤1.8, 0.001≤b≤0.1), LiₐMn_{1-b}G_{b}O₂ (0.90≤a≤1.8, 0.001≤b≤0.1), LiₐMn₂G_{b}O₄ (0.90≤a≤1.8, 0.001≤b≤0.1), LiₐMn_{1-g}G_{g}PO₄ (0.90≤a≤1.8, 0≤g≤0.5), Li_{(3-f)}Fe₂(PO₄)₃ (0≤f≤2), and LiₐFePO₄ (0.90≤a≤1.8).

In the chemical formulae herein, A may be Ni, Co, Mn, or a combination thereof, X may be Al, Ni, Co, Mn, Cr, Fe, Mg, Sr, V, a rare-earth element, or a combination thereof, D may be O, F, S, P, or a combination thereof, G may be Al, Cr, Mn, Fe, Mg, La, Ce, Sr, V, or a combination thereof, and L¹ may be Mn, Al, or a combination thereof.

For example, the positive electrode active material may be a high nickel-based positive electrode active material having a nickel content (e.g., amount) of equal to or greater than about 80 mol %, equal to or greater than about 85 mol %, equal to or greater than about 90 mol %, equal to or greater than about 91 mol %, or equal to or greater than about 94 mol % and equal to or less than about 99 mol %, based on (or relative to) 100 mol % of metal devoid of lithium in the lithium transition metal composite oxide. The high nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material and may further include a binder and/or a conductive material.

For example, the negative electrode active material layer AML2 may include a negative electrode active material in an amount of about 90 wt % to about 99 wt %, a binder in an amount of about 0.5 wt % to about 5 wt %, and a conductive material in an amount of about 0 wt % to about 5 wt %.

The binder may serve to improve attachment of negative electrode active material particles to each other and also to improve attachment of the negative electrode active material to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include styrene-butadiene rubber, (meth)acrylated styrene-butadiene rubber, (meth)acrylic rubber, butyl rubber, fluoro elastomer, polyethylene oxide, polyvinyl pyrrolidone, polyepichlorohydrine, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

If (e.g., when) an aqueous binder is used as the negative electrode binder, a cellulose-based compound capable of providing or increasing viscosity may further be included. The cellulose-based compound may include one or more of carboxymethyl cellulose, hydroxypropylmethyl cellulose, methyl cellulose, and alkali metal salts thereof. The alkali metal may include Na, K, and/or Li.

The dry binder may include a fibrillizable polymer material, for example, polytetrafluoroethylene, polyvinylidene fluoride, polyvinylidene fluoride-hexafluoropropylene copolymer, polyethylene oxide, or a combination thereof.

The conductive material (e.g., electron conductor) may be used to provide an electrode with conductivity, and any suitable conductive material without causing chemical change of a battery may be used as the conductive material to constitute the battery. For example, the conductive material may include a carbon-based material such as natural graphite, artificial graphite, carbon black, acetylene black, Ketjenblack, carbon fiber, carbon nano-fiber, and/or carbon nano-tube; a metal powder or metal fiber including one or more of copper, nickel, aluminum, and/or silver; a conductive polymer such as a polyphenylene derivative; or a mixture thereof.

The current collector COL2 may include a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include a material that reversibly intercalates and deintercalates lithium ions, lithium metal, a lithium metal alloy, a material that dopes and de-dopes lithium, or transition metal oxide.

The material that reversibly intercalates and deintercalates lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, or fiber-shaped natural or artificial graphite, and the amorphous carbon may include soft carbon, hard carbon, mesophase pitch carbon, or calcined coke.

The lithium metal alloy may include an alloy of lithium and metal that is selected from among Na, K, Rb, Cs, Fr, Be, Mg, Ca, Sr, Si, Sb, Pb, In, Zn, Ba, Ra, Ge, Al, and Sn.

The material that dopes and de-dopes lithium may include a Si-based negative electrode active material or a Sn-based negative electrode active material. The Si-based negative electrode active material may include silicon, silicon-carbon composite, SiOx (0<x≤2), Si-Q alloy (where Q is alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include Sn, SnO₂, SnOx (0<x<2), a Sn-based alloy, a combination thereof.

The silicon-carbon composite may be a composite of silicon and amorphous carbon. According to one or more embodiments, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be present dispersed in an amorphous carbon matrix.

The silicon-carbon composite may further include crystalline carbon. For example, the silicon-carbon composite may include a core including crystalline carbon and silicon particles and may also include an amorphous carbon coating layer positioned on a surface of the core.

The Si-based negative electrode active material or the Sn-based negative electrode active material may be used in combination with a carbon-based negative electrode active material.

### Separator 30

Based on type or kind of the rechargeable lithium battery, the separator 30 may be present between positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate, which coating layer includes an organic material, an inorganic material, or a combination thereof.

The porous substrate may be a polymer layer including one selected from among polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be a copolymer or mixture including two or more of the materials mentioned herein.

The organic material may include a polyvinylidenefluoride-based copolymer or a (meth)acrylic copolymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be present mixed in one coating layer or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may serve as a medium for transmitting ions that participate in an electrochemical reaction of a battery.

The non-aqueous organic solvent may include a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and/or butylene carbonate (BC).

The ester-based solvent may include methyl acetate, ethyl acetate, n-propyl acetate, dimethyl acetate, methyl propionate, ethyl propionate (EP), propyl propionate (PP), decanolide, mevalonolactone, valerolactone, or caprolactone.

The ether-based solvent may include dibutyl ether, tetraglyme, diglyme, dimethoxyethane, 2-methyltetrahydrofuran, 2.5-dimethyltetrahydrofuran, and/or tetrahydrofuran. The ketone-based solvent may include cyclohexanone. The aprotic solvent may include one or more selected from among nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane and/or 1.4-dioxolane; and/or sulfolanes.

The non-aqueous organic solvent may be used alone or in a mixture of two or more substances.

In some embodiments, if (e.g., when) a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a battery and plays a role in enabling a basic operation of a rechargeable lithium battery and in promoting the movement of lithium ions between positive and negative electrodes. For example, the lithium salt may include at least one selected from among LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N, lithium bis(fluorosulfonyl)imide) (LiFSI), LiC₄F₉SO₃, LiClO₄, LiAlO₂, LiAlCl₄, LiPO₂F₂, LiN(CₓF₂ₓ₊₁SO₂) (C_{y}F_{2y+1}SO₂) (where x and y are each independently a natural number between 1 and 20), LiCl, LiI, LiB(C₂O₄)₂ or lithium bis(oxalato) borate (LiBOB), lithium difluoro(oxalato) borate (LiDFOB), and lithium difluoro(bisoxalato) phosphate (Li[PF₂(C₂O₄)₂], LiDFBOP).

The lithium salt may have a concentration of about 0.1 M to about 2.0 M. If (e.g., when) the lithium salt has a concentration within the range disclosed herein, the electrolyte may appropriate or suitable conductivity and viscosity to exhibit superior electrolyte performance and to allow lithium ions to effectively move.

### Rechargeable Lithium Battery

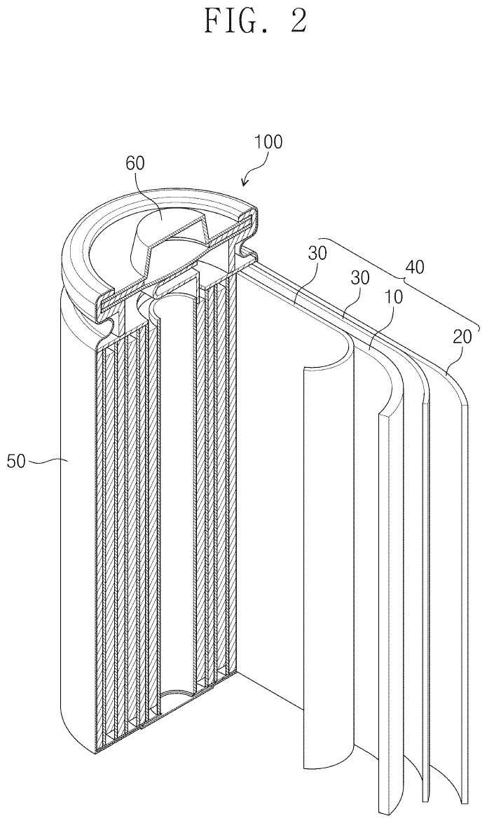

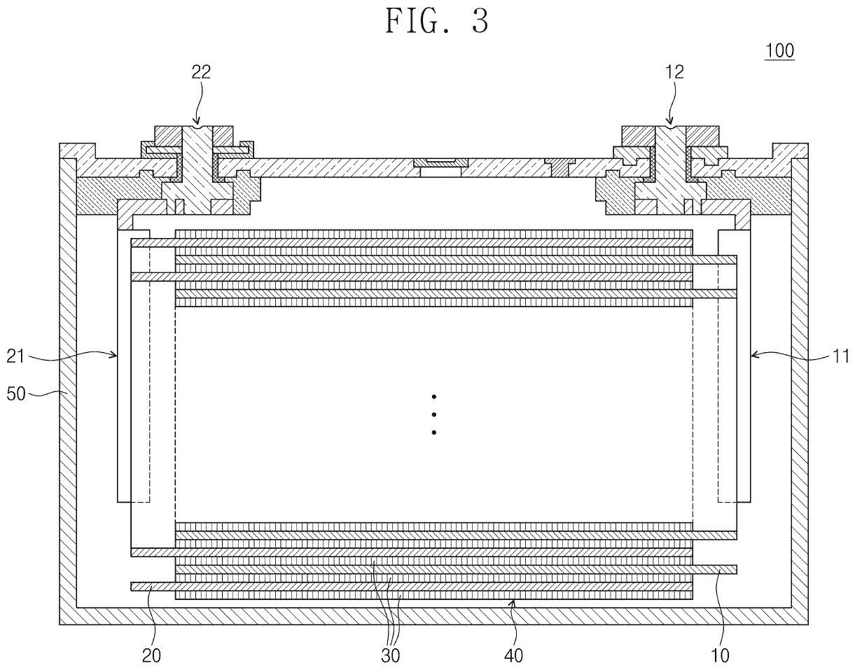

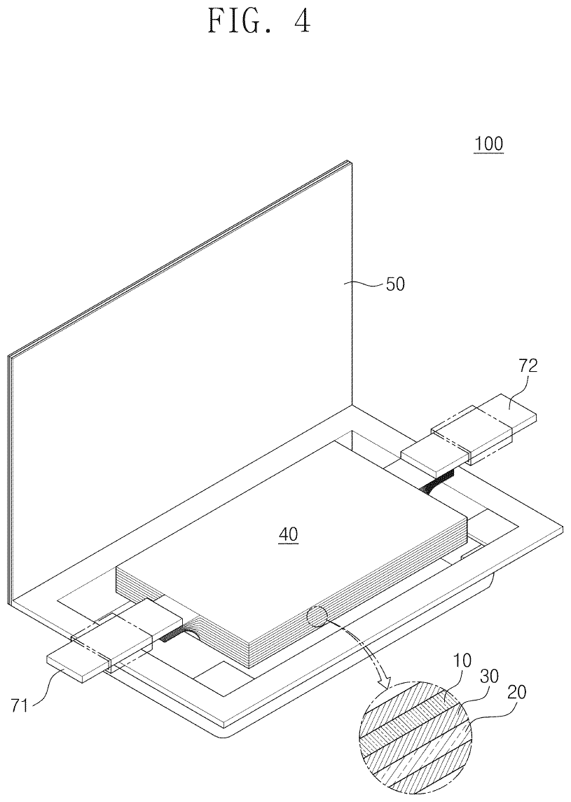

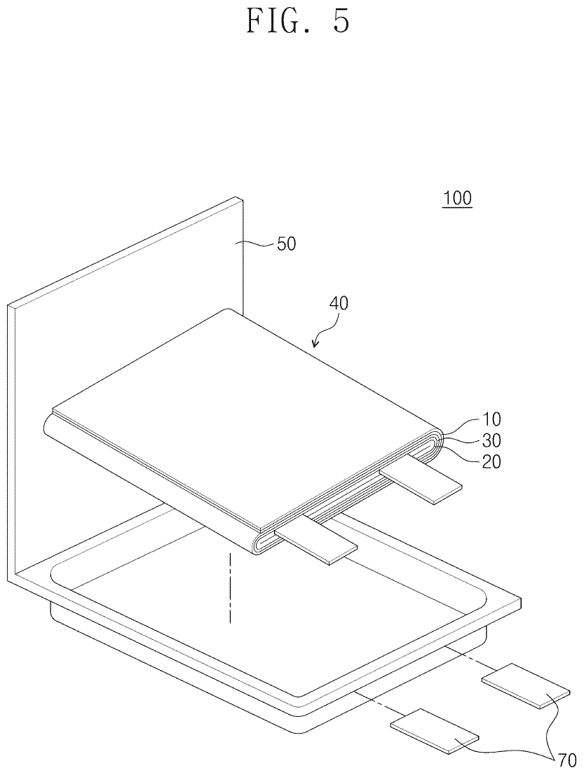

Based on the shape of a rechargeable lithium battery, the rechargeable lithium battery may be classified into cylindrical, prismatic, pouch, and coin types (kinds). In FIGS. 2 to 5 illustrating simplified diagrams each showing a rechargeable lithium battery according to one or more embodiments, FIG. 2 shows a cylindrical battery, FIG. 3 shows a prismatic battery, and FIGS. 4 and 5 show pouch-type or kind batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50 as illustrated in FIG. 2. In some embodiments, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include electrode tabs 70, or a positive electrode tab 71 and a negative electrode tab 72, which electrode tabs 70, 71 and 72 serve as an electrical path for externally inducing a current generated in the electrode assembly 40.

The following description will focus on an electrolyte for a rechargeable lithium battery according to some embodiments of the present disclosure.

An electrolyte for a rechargeable lithium battery according to the present embodiment may include a non-aqueous organic solvent, a lithium salt, and a first additive including a compound represented (e.g., expressed) by Chemical Formula 1.

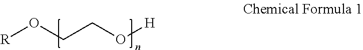

In Chemical Formula 1, n may be an integer of 5 to 10.

In Chemical Formula 1, R may be a substituted or unsubstituted C3 to C15 alkyl group. For example, the number of carbon atoms in R (i.e., the substituted or unsubstituted branched C3 to C15 alkyl group) may range from about 3 to about 10 or from about 5 to about 8.

In Chemical Formula 1, R may be a branched alkyl group. For example, the branched alkyl group may be 1-methylethyl, 1-methylpropyl, 2-methylpropyl, 1-methylbutyl, 2-methylbutyl, 3-methylbutyl, 1-ethylbutyl, 2-ethylbutyl, 3-ethylbutyl, 1-propylbutyl, 2-propylbutyl, 3-propylbutyl, 1-methylpentyl, 2-methylpentyl, 3-methylpentyl, 4-methylpentyl, 1-ethylpentyl, 2-ethylpentyl, 3-ethylpentyl, 4-ethylpentyl, 1-propylpentyl, 2-propylpentyl, 3-propylpentyl, 4-propylpentyl, 1-butylpentyl, 2-butylpentyl, 3-butylpentyl, 4-butylpentyl, 1-methylhexyl, 2-methylhexyl, 3-methylhexyl, 4-methylhexyl, 5-methylhexyl, 1-ethylhexyl, 2-ethylhexyl, 3-ethylhexyl, 4-ethylhexyl, 5-ethylhexyl, 1-propylhexyl, 2-propylhexyl, 3-propylhexyl, 4-propylhexyl, 5-propylhexyl, 1-butylhexyl, 2-butylhexyl, 3-butylhexyl, 4-butylhexyl, or 5-butylhexyl.

In one or more embodiments of the present disclosure, in the compound represented (e.g., expressed) by Chemical Formula 1, R may be 1-ethylpentyl. For example, the electrolyte may include a compound represented (e.g., expressed) by Chemical Formula 1-1.

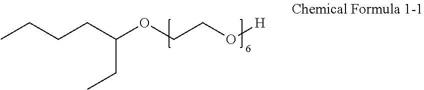

The first additive including the compound represented (e.g., expressed) by Chemical Formula 1 may serve as a surfactant in the electrolyte to improve impregnability of the electrolyte, For example, R of the compound represented (e.g., expressed) by Chemical Formula 1 may have a branched structure, and thus the impregnability of the electrolyte may be further improved. Therefore, there may be a significant reduction in amount of the electrolyte present on a surface without being impregnated into a high-density negative electrode. In conclusion, a thickness of the rechargeable lithium battery including the electrolyte may be reduced to increase an energy density (e.g., of the rechargeable lithium battery). In some embodiments, the increased impregnability may uniformly (e.g., substantially uniformly) form a film between the negative electrode and the electrolyte, and thus lifespan characteristics may be improved.

The electrolyte for a rechargeable lithium battery according to the present embodiment may include the compound represented (e.g., expressed) by Chemical Formula 1 and may further include a second additive that may be or include at least one selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propenesultone (PST), propanesultone (PS), lithium tetrafluoroborate (LiBF₄), lithium difluorophosphate (LiPO₂F₂), lithium difluorobis(oxalato) phosphate (LiDFBOP), lithium difluoro(oxalato) borate (LiDFOB), and 2-fluoro biphenyl (2-FBP).

In one or more embodiments, the second additive (i.e., the electrolyte for a rechargeable lithium battery) may further include one or both (e.g., simultaneously) of fluoroethylene carbonate (FEC) and vinylethylene carbonate (VEC). In one or more embodiments, an amount of the second additive may be about 1 wt % to about 20 wt %, or about 5 wt % to about 12 wt %, relative to a total weight of (100 wt % of) the electrolyte.

In one or more embodiments, the second additive may include fluoroethylene carbonate (FEC), vinylethylene carbonate (VEC), and lithium tetrafluoroborate (LiBF₄). For example, an amount of fluoroethylene carbonate (FEC) may be about 6 wt % to about 8 wt %, an amount of vinylethylene carbonate (VEC) may be about 0.5 wt % to about 2 wt %, and an amount of lithium tetrafluoroborate (LiBF₄) may be about 0.05 wt % to about 1 wt %, relative to a total weight of the electrolyte.

In one or more embodiments, the second additive (i.e., the electrolyte for a rechargeable lithium battery) may further include lithium difluoro(oxalato) borate (LiDFOB). For example, lithium difluoro(oxalato) borate (LiDFOB) may be included in an amount of about 1 wt % to about 5 wt % relative to the total weight of the electrolyte.

In one or more embodiments, the lithium salt may include LiPF₆.

In one or more embodiments, the lithium salt may have a concentration of about 0.1 M to about 2.0 M. For example, the lithium salt may have a concentration of equal to, or greater than, about 0.5 M or about 1.0 M. The lithium salt may have a concentration of equal to, or less than, about 2.0 M, equal to, or less than, about 1.7 M, or equal to, or less than, about 1.5 M.

In another embodiment, a rechargeable lithium battery may be provided which includes a positive electrode including a positive electrode active material, a negative electrode including a negative electrode active material, and the electrolyte as described herein.

In one or more embodiments, the positive electrode active material may include at least one selected from among lithium cobalt-based oxide, lithium nickel-based oxide, lithium manganese-based oxide, lithium iron phosphate-based compound, and cobalt-free nickel-manganese-based oxide. For example, the positive electrode active material may include lithium cobalt-based oxide.

In one or more embodiments, the negative electrode active material may include at least one selected from among a carbon-based negative electrode active material, a Si-based negative electrode active material, and a Sn-based negative electrode active material.

In one or more embodiments, the negative electrode may have a mixture density of equal to or greater than about 1.7 gram per cubic centimeter (g/cc). For example, the negative electrode may have a mixture density ranging from about 1.7 g/cc to about 3.0 g/cc or from about 1.7 g/cc to about 2.5 g/cc.

In this description, the term “mixture density” may be obtained by dividing a weight of the negative electrode by a volume of its components (e.g., active material, binder, conductive material, and so forth) excluding a current collector (e.g., from the electrode). For example, a mixture density of the negative electrode may refer to a density of the negative electrode active material layer AML2.

An electrolyte according to the present disclosure may have superior impregnability, and thus may be easily impregnated into a high-density negative electrode whose mixture density is equal to, or greater than, about 1.7 g/cc. Thus, a rechargeable lithium battery including the electrolyte of the present disclosure may have an increased energy density and excellent or suitable lifespan characteristics. In some embodiments, a rechargeable lithium battery including the electrolyte of the present disclosure may have reduced internal resistance and increased ion conductivity.

A rechargeable lithium battery according to one or more embodiments of the present disclosure may be applied to automotive vehicles, mobile phones, and/or any other electrical devices, but the present disclosure is not limited thereto.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or +30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

The following will describe Example Embodiments and Comparative Examples of the present disclosure. The following Example Embodiments, however, are merely one or more possible examples, and the present disclosure is not limited to the Example Embodiments discussed herein.

### EXAMPLE EMBODIMENTS AND COMPARATIVE EXAMPLES

### Example Embodiment 1

### (1) Preparation of Electrolyte

1.3 M LiPF₆ was dissolved in a non-aqueous organic solvent including ethylene carbonate (EC), propylene carbonate (PC), ethyl propionate (EP), propyl propionate (PP) mixed in a volume ratio of about 10:15:30:45, and then first and second additives were added to prepare an electrolyte.

Based on the total weight of the electrolyte, 7 wt % of fluoroethylene carbonate (FEC), 1 wt % of vinylethylene carbonate (VEC), and 0.2 wt % of LiBF₄ were added as second additives.

Based on the total weight of the electrolyte, 1 wt % of the compound represented (e.g., expressed) by Chemical Formula 1-1 was added as a first additive.

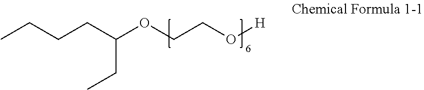

### (2) Fabrication of Rechargeable Lithium Battery

LiNiCoAlO₂ (NCA) as a positive electrode active material, polyvinylidene fluoride as a binder, and acetylene black as a conductive material were mixed in a weight ratio of 96:3:1, and the mixture was distributed in N-methyl pyrrolidone to prepare a positive electrode active material slurry.

The positive electrode active material slurry was coated on an Al foil of 15 micrometer (μm) in thickness, dried at 100° C., and then pressed to manufacture a positive electrode.

A silicon negative electrode active material, a styrene-butadiene rubber binder, and carboxymethyl cellulose were mixed in a weight ratio of 98:1:1, and the mixture was dispersed in distilled water to prepare a negative electrode active material slurry.

The negative electrode active material slurry was coated on a Cu foil of 10 μm in thickness, dried at 100° C., and then pressed to manufacture a negative electrode whose mixture density is 1.7 gram per cubic centimeter (g/cc).

The positive electrode, the negative electrode, and a polyethylene separator of 10 μm in thickness were assembled to manufacture an electrode assembly, and the electrolyte was introduced to fabricate a rechargeable lithium battery.

### Example Embodiment 2

An electrolyte and a rechargeable lithium battery were fabricated by the same method as that in Example Embodiment 1, except that the compound represented (e.g., expressed) by Chemical Formula 1-1 was added in an amount of 2 wt %.

### Example Embodiment 3

An electrolyte and a rechargeable lithium battery were fabricated by the same method as that in Example Embodiment 1, except that the compound represented (e.g., expressed) by Chemical Formula 1-1 as added in an amount of 3 wt %.

### Example Embodiment 4

An electrolyte and a rechargeable lithium battery were fabricated by the same method as that in Example Embodiment 3, except that lithium difluoro(oxalato) borate (LiDFOB) was further added as a second additive in an amount of 1 wt % relative to the total weight of the electrolyte.

### Comparative Example 1

An electrolyte and a rechargeable lithium battery were fabricated by the same method as that of Example Embodiment 1, except the compound represented (e.g., expressed) by Chemical Formula 1-1 was not added as a first additive if (e.g., when) the electrolyte was prepared.

### Comparative Example 2

An electrolyte and a rechargeable lithium battery were fabricated by the same method as that of Example Embodiment 1, except that in place of the compound represented (e.g., expressed) by Chemical Formula 1-1, the compound represented (e.g., expressed) by Chemical Formula 2 was added as a first additive in an amount of 1 wt % relative to the total weight of the electrolyte.

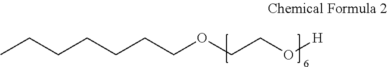

### Comparative Example 3

An electrolyte and a rechargeable lithium battery were fabricated by the same method as that of Example Embodiment 1, except that in place of the compound represented (e.g., expressed) by Chemical Formula 1-1, a compound represented (e.g., expressed) by Chemical Formula 3 was added as a first additive in an amount of 1 wt % relative to the total weight of the electrolyte.

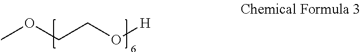

### Evaluation Example 1: Electrolyte Impregnability Test

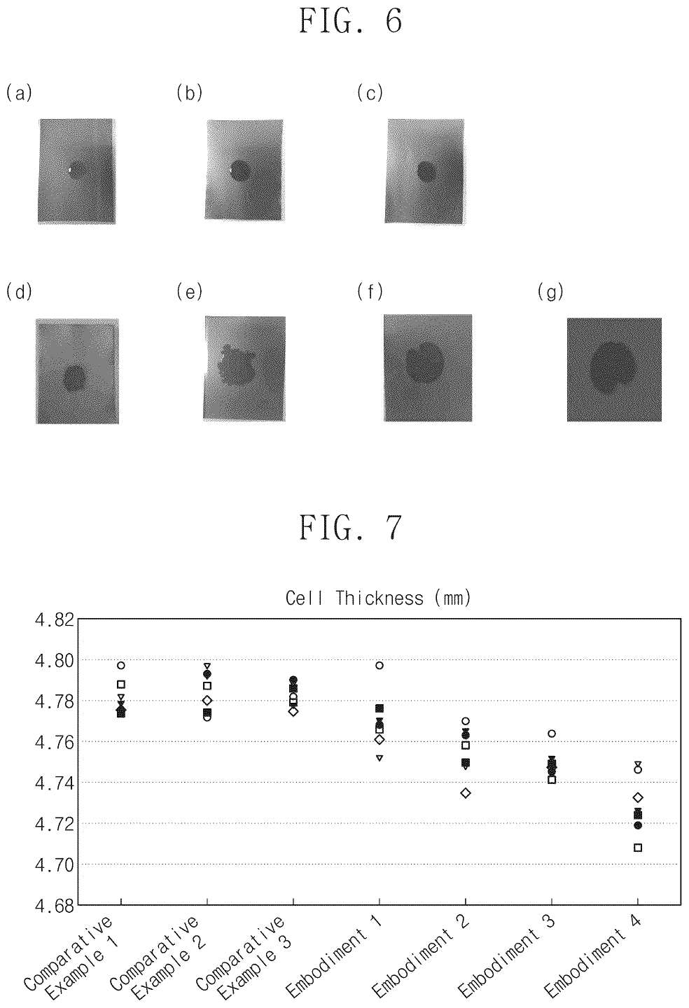

The electrolyte prepared according to Example Embodiments 1 to 4 and Comparative Examples 1 to 3 was dropped in an amount of 0.002 milliliter (mL) to a surface of the negative electrode manufactured according to Example Embodiment 1, and then an area of the electrolyte on the surface of the negative electrode was captured after 1 minute elapsed from the time point of drop and the degree of impregnability was evaluated based on the captured image. The captured image and the degree of impregnability are shown in FIG. 6 and Table 1, respectively.

The degree of impregnability was evaluated based on a spread area of the electrolyte on the negative electrode. 1: A diameter of the electrolyte drop is less than 1 millimeter (mm), 2: A diameter of the electrolyte drop is less than 1.5 mm, 3: A diameter of the electrolyte drop is less than 2.0 mm, 4: A diameter of the electrolyte drop is less than 2.5 mm, and 5: A diameter of the electrolyte drop is less than 3.0 mm.

TABLE 1

| Category | Impregnability |
|---|---|
| Comparative Example 1 | 1 |
| Comparative Example 2 | 1 |
| Comparative Example 3 | 1 |
| Example Embodiment 1 | 2 |
| Example Embodiment 2 | 3 |
| Example Embodiment 3 | 5 |
| Example Embodiment 4 | 5 |

Referring to FIG. 6, captured images (a), (b), and (c) show the area of the electrolyte of Comparative Examples 1, 2, and 3, respectively, and captured images (d), (e), (f), and (g) show the area of the electrolyte of Example Embodiments 1, 2, 3, and 4, respectively. From the captured images, it may be ascertained that the electrolytes of Example Embodiments 1 to 4 each have impregnability significantly superior to that of each of the electrolytes of Comparative Examples 1 to 3. For example, it may be ascertained that impregnability to the negative electrode is remarkably improved if (e.g., when) the electrolyte that was utilized included a first additive being a compound represented (e.g., expressed) by Chemical Formula 1.

In some embodiments, it may be ascertained that impregnability was considerably improved if (e.g., when) lithium difluoro(oxalato) borate (LiDFOB) was further added as a second additive to an electrolyte including the compound represented (e.g., expressed) by Chemical Formula 1 (see Example Embodiment 4).

### Evaluation 2: Thickness of Rechargeable Lithium Battery

A thickness of the rechargeable lithium battery (cell) fabricated according to Comparative Examples 1 to 3 and Example Embodiments 1 to 4 was measured, and the results are shown in FIG. 7. Seven cells were fabricated in each of the Example Embodiments and Comparative Examples, and an average thickness of the seven cells was listed in Table 2.

TABLE 2

| | Average cell thickness |
|---|---|
| Category | (mm) |
| Comparative Example 1 | 4.783 |
| Comparative Example 2 | 4.784 |
| Comparative Example 3 | 4.784 |
| Example Embodiment 1 | 4.770 |
| Example Embodiment 2 | 4.756 |
| Example Embodiment 3 | 4.750 |
| Example Embodiment 4 | 4.732 |

Referring to FIGS. 2 and 7, it may be ascertained that impregnability is improved due to the addition of the compound represented (e.g., expressed) by Chemical Formula 1 to the electrolyte as a first additive, and that the fabricated rechargeable lithium battery decreased in thickness (see Comparative Example 1 and Example Embodiments 1 to 4).

In particular, it may be ascertained that the thickness is remarkably smaller in the rechargeable lithium batteries of Example Embodiments 1 to 4, each including a first additive and a compound represented (e.g., expressed) by Chemical Formula 1-1 having a branched alkyl group, as compared to the rechargeable lithium batteries of Comparative Example 1 not including a compound represented (e.g., expressed) by Chemical Formula 1-1 as a first additive, and Comparative Examples 2 and 3 including as a first additive, a compound represented (e.g., expressed) by Chemical Formula 2 or Chemical Formula 3, respectively, in which a linear alkyl group is present.

In conclusion, it may be ascertained that an electrolyte including the compound represented (e.g., expressed) by Chemical Formula 1 as a first additive has superior impregnability to be uniformly (e.g., substantially uniformly) incorporated into a negative electrode and thus a thickness of fabricated cells is reduced to increase an energy density (e.g., of the negative electrode).

An electrolyte for a rechargeable lithium battery according to one or more embodiments of the present disclosure may include the compound represented (e.g., expressed) by Chemical Formula 1 as a first additive to thereby have excellent or suitable impregnability.

A rechargeable lithium battery according to one or more embodiments of the present disclosure may include the electrolyte and may thereby have superior energy density and lifespan characteristics.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

While this disclosure has been described in connection with what is presently considered to be example embodiments, it is to be understood that the present disclosure is not limited to the disclosed embodiments and is intended to cover one or more suitable modifications and equivalent arrangements included within the spirit and scope of the appended claims, and equivalents thereof. Therefore the aforementioned embodiments should be understood to be examples but not limiting this disclosure in any way.

What is claimed is:

1. An electrolyte, the electrolyte comprising:
a non-aqueous organic solvent;
a lithium salt; and
a first additive comprising a compound represented by Chemical Formula 1, 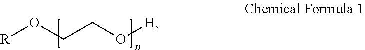
in Chemical Formula 1,
R being a substituted or unsubstituted branched C3 to C15 alkyl group, and
n being an integer of 5 to 10,
wherein the electrolyte is for a rechargeable lithium battery.

2. The electrolyte as claimed in claim 1, wherein a number of carbon atoms in the substituted or unsubstituted branched C3 to C15 alkyl group is 3 to 10.

3. The electrolyte as claimed in claim 1, wherein R is any one selected from among 1-methylethyl, 1-methylpropyl, 2-methylpropyl, 1-methylbutyl, 2-methylbutyl, 3-methylbutyl, 1-ethylbutyl, 2-ethylbutyl, 3-ethylbutyl, 1-propylbutyl, 2-propylbutyl, 3-propylbutyl, 1-methylpentyl, 2-methylpentyl, 3-methylpentyl, 4-methylpentyl, 1-ethylpentyl, 2-ethylpentyl, 3-ethylpentyl, 4-ethylpentyl, 1-propylpentyl, 2-propylpentyl, 3-propylpentyl, 4-propylpentyl, 1-butylpentyl, 2-butylpentyl, 3-butylpentyl, 4-butylpentyl, 1-methylhexyl, 2-methylhexyl, 3-methylhexyl, 4-methylhexyl, 5-methylhexyl, 1-ethylhexyl, 2-ethylhexyl, 3-ethylhexyl, 4-ethylhexyl, 5-ethylhexyl, 1-propylhexyl, 2-propylhexyl, 3-propylhexyl, 4-propylhexyl, 5-propylhexyl, 1-butylhexyl, 2-butylhexyl, 3-butylhexyl, 4-butylhexyl, and 5-butylhexyl.

4. The electrolyte as claimed in claim 1, wherein the compound is in an amount of about 1 wt % to about 5 wt % relative to a total weight of the electrolyte.

5. The electrolyte as claimed in claim 1, wherein the non-aqueous organic solvent comprises at least one selected from among ethylene carbonate, propylene carbonate, dimethyl carbonate, diethyl carbonate, dipropyl carbonate, methylpropyl carbonate, ethylpropyl carbonate, methylethyl carbonate, butylene carbonate, methyl acetate, ethyl acetate, n-propyl acetate, dimethyl acetate, methyl propionate, ethyl propionate, propyl propionate, decanolide, mevalonolactone, valerolactone, and caprolactone.

6. The electrolyte as claimed in claim 1, wherein the non-aqueous organic solvent comprises at least one selected from among ethylene carbonate (EC), propylene carbonate (PC), ethyl propionate (EP), and propyl propionate (PP).

7. The electrolyte as claimed in claim 1, wherein a concentration of the lithium salt is about 0.1 M to about 2.0 M.

8. The electrolyte as claimed in claim 1, further comprising a second additive comprising at least one selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile, succinonitrile, 1,3,6-hexane tricyanide, propenesultone, propanesultone, lithium tetrafluoroborate (LiBF₄), lithium difluorophosphate (LiPO₂F₂), lithium difluorobis(oxalato) phosphate (LiDFBOP), lithium difluoro(oxalato) borate (LiDFOB), and 2-fluoro biphenyl (2-FBP).

9. The electrolyte as claimed in claim 8, wherein an amount of the second additive is about 1 wt % to about 20 wt % relative to a total weight of the electrolyte.

10. The electrolyte as claimed in claim 8, wherein the second additive comprises at least one selected from among fluoroethylene carbonate (FEC), vinylethylene carbonate (VEC), lithium tetrafluoroborate (LiBF₄), and lithium difluoro (oxalato) borate (LiDFOB).

11. The electrolyte as claimed in claim 8, wherein the second additive comprises fluoroethylene carbonate (FEC), vinylethylene carbonate (VEC), and lithium tetrafluoroborate (LiBF₄).

12. The electrolyte as claimed in claim 11, wherein, relative to a total weight of the electrolyte, an amount of fluoroethylene carbonate (FEC) is about 6 wt % to about 8 wt %, an amount of vinylethylene carbonate (VEC) is about 0.5 wt % to about 2 wt %, and an amount of lithium tetrafluoroborate (LiBF₄) is about 0.05 wt % to about 1 wt %.

13. The electrolyte as claimed in claim 11, wherein the second additive further comprises lithium difluoro(oxalato) borate (LiDFOB).

14. The electrolyte as claimed in claim 13, wherein an amount of lithium difluoro(oxalato) borate (LiDFOB) is about 1 wt % to about 5 wt % relative to a total weight of the electrolyte.

15. The electrolyte as claimed in claim 1, wherein the lithium salt comprises at least one selected from among LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N, lithium bis(fluorosulfonyl)imide), LiC₄F₉SO₃, LiClO₄, LiAlO₂, LiAlCl₄, LiPO₂F₂, LiN(CₓF₂ₓ₊₁SO₂) (C_{y}F_{2y+1}SO₂) where x and y are each independently a natural number between 1 and 20, LiCl, LiI, LiB(C₂O₄)₂, lithium difluoro(oxalato) borate (LiDFOB), and lithium difluoro(bisoxalato) phosphate.

16. The electrolyte as claimed in claim 1, wherein the non-aqueous organic solvent comprises ethylene carbonate (EC), propylene carbonate (PC), ethyl propionate (EP), and propyl propionate (PP) in a volume ratio of about 10:15:30:45.

17. A rechargeable lithium battery, comprising:
a positive electrode that comprises a positive electrode active material;
a negative electrode that comprises a negative electrode active material; and
the electrolyte as claimed in claim 1.

18. The rechargeable lithium battery as claimed in claim 17, wherein the positive electrode active material comprises lithium cobalt-based oxide, lithium nickel-based oxide, lithium manganese-based oxide, lithium iron phosphate-based compounds, cobalt-free nickel-manganese-based oxide, or any combination thereof.

19. The rechargeable lithium battery as claimed in claim 17, wherein the negative electrode active material comprises at least one selected from among a carbon-based negative electrode active material, a Si-based negative electrode active material, and a Sn-based negative electrode active material.

20. The rechargeable lithium battery as claimed in claim 17, wherein a mixture density of the negative electrode is equal to, or greater than, about 1.7 gram per cubic centimeter (g/cc).
